(19) United States
(12) Patent Application Publication
(10) Pub. No.: US 2025/0070343 A1
(43) Pub. Date: Feb. 27, 2025

(54) CAP, BATTERY, AND BATTERY PACK

(71) Applicant: HUIZHOU EVE POWER CO., LTD., HUIZHOU (CN)

(72) Inventors: WEN CHEN, HUIZHOU (CN); SHANGYI LI, HUIZHOU (CN); ZHIMING WANG, HUIZHOU (CN)

(21) Appl. No.: 18/812,971

(22) Filed: Aug. 22, 2024

(30) Foreign Application Priority Data
Aug. 23, 2023 (CN) 202322276210.0

(51) Int. Cl. H01M 50/188; H01M 50/152

(52) U.S. Cl. CPC H01M 50/188; H01M 50/152

(57) ABSTRACT

A cap includes: a cap body; a pole; and a sealing nail. The pole is connected to the cap body. The pole defines a slot; a plane in which an upper surface of the pole is located is defined as a first plane; a slot wall includes a first section face; the first section face is connected to the first plane; an angle between the first section face and the first plane is θ₂. The sealing nail is arranged in the slot and welded to the pole. A plane in which an upper surface of the sealing nail is located is defined as a second plane; a side wall of the sealing nail includes a first portion face; the first portion face is connected to the second plane; an angle between the first portion face and the second plane is θ₁. The angle θ₁≥the angle θ₂.

### CROSS REFERENCE TO RELATED APPLICATIONS

The present application claims priority of the Chinese patent application No. 202322276210.0, filed on Aug. 23, 2023, contents of which are incorporated herein by its entireties.

### TECHNICAL FIELD

The present disclosure relates to the field of batteries, and in particular to a cap, a battery, and a battery pack.

### BACKGROUND

A lithium-ion battery has a high energy density, a fast charging and discharging rate, a long cycle life, and causes no pollution. Therefore, the lithium-ion battery is widely used in portable electronic devices, communications, energy storage and electric vehicles.

A type of lithium-ion batteries is a cylindrical battery. The cylindrical battery includes a case, a winding core arranged inside the case, and a cap that covers the case. A pole is arranged on the cap. In a process of manufacturing the cylindrical battery, a hole is defined in the pole to allow the pole and a positive-electrode current collector plate to meet processing requirements for external penetration welding. After welding of the pole and the positive-electrode current collector plate is completed, in order to ensure sealing of a region of the hole and structural strength of the battery, a sealing nail is to be used during the welding.

For a sealing method in the art, since a location at which the sealing nail is placed in the hole of the pole cannot be determined, a poor welding effect may be achieved. For example, tilting up and protrusion may be caused.

### SUMMARY OF THE DISCLOSURE

To solve the above technical problem, in a first aspect, the present application disclose provides a cap, including: a cap body; a pole; and a sealing nail. The pole is connected to the cap body. The pole defines a slot; a plane in which an upper surface of the pole is located is defined as a first plane; a slot wall of the slot includes at least a first section face; the first section face is connected to the first plane; an angle between the first section face and the first plane is θ₂. The sealing nail is arranged in the slot and welded to the pole. A plane in which an upper surface of the sealing nail is located is defined as a second plane; a side wall of the sealing nail includes at least a first portion face; the first portion face is connected to the second plane; an angle between the first portion face and the second plane is θ₁. The angle θ₁≥the angle θ₂.

In this way, the angle θ₁ between the first portion face and the second plane of the sealing nail is greater than the angle θ₂ between the first section face and the first plane of the slot. Therefore, when the sealing nail is arranged in the slot of the pole to be welded to the pole, the side wall of the sealing nail can be supported by the slot wall of the slot. The slot wall of the slot limits the location at which the sealing nail is arranged. The sealing nail can be adjusted to be placed flatly in the slot, i.e., the second plane of the sealing nail is parallel with the first plane of the pole. A gap between the sealing nail and the slot wall at various locations may be uniform as much as possible. Compared to the technical solution in the art in which the angle θ₁ between the first portion face and the second plane is less than the angle θ₂ between the first section face of the slot and the first plane of the slot, when the sealing nail is arranged in the slot and is welded to the pole by following the present disclosure, warping, protrusions, and poor welding can be avoided.

In some embodiments, the slot wall of the slot comprises the first section face and a second section face connected to the first section face; the second section face is disposed away from the first plane; an angle between the first plane and a plane on which the second section face is located is θ₄, and the angle θ₂≥the angle θ₄.

The side wall of the sealing nail comprises the first portion face and a second portion face; the first portion face is disposed corresponding to the first section face, and the second portion face is disposed corresponding to the second section face; an angle between the second plane 31 and a plane on which the second portion face is located is θ₃, and the angle θ₁>the angle θ₃, the angle θ₄≥the angle θ₃.

In some embodiments, an arc transition surface is formed between the first portion face and the second portion face.

In some embodiments, the angle θ₄>the angle θ₃.

In some embodiments, an outer diameter D1 of the sealing nail is in a range of 3 mm-20 mm, a diameter D2 of the slot is in a range of 3 mm to 30 mm, and the diameter D2≥the outer diameter D1.

In some embodiments, the angle θ₁>the angle θ₂, and the diameter D2>the outer diameter D1.

In some embodiments, a height H1 of the sealing nail is in a range of 3 mm-30 mm, and a height H2 of the slot is in a range of 3 mm-30 mm.

In a second aspect, the present disclosure provides a battery, including: a case; a winding core, arranged in the case; and the cap as described in the above. The cap covers the case.

In some embodiments, an outer diameter D3 of the case is in a range of 20 mm-80 mm, and a total height H3 of the case and the cap body is in a range of 80 mm-160 mm.

In a third aspect, the present disclosure provides a battery pack, including the battery as described in the above.

### BRIEF DESCRIPTION OF THE DRAWINGS

FIG. 1 is a structural schematic view of a battery according to some embodiments of the present disclosure.

FIG. 2 is a cross-sectional view of the battery shown in FIG. 1.

FIG. 3 is an enlarged view of a portion I shown in FIG. 2.

FIG. 4 is a structural schematic view of a pole shown in FIG. 3.

FIG. 5 is a structural schematic view of a sealing nail shown in FIG. 3.

FIG. 6 is a structural schematic view of assembling between the pole and the sealing nail in the art.

### REFERENCE NUMERALS IN THE DRAWINGS

100—cap, 10—cap body, 20—pole, 21—slot, 22—first plane, 23—first section face, 24—second section face, 30—sealing nail, 31—second plane, 32—first portion face, 33—second portion face, 34—arc transition face, 200—battery, 40—case, 50—winding core.

### DETAILED DESCRIPTION

For better understanding and implementation, technical solutions in the embodiments of the present disclosure will be clearly and completely described below by referring to the accompanying drawings in the embodiments of the present disclosure.

In the description of the present disclosure, to be noted that the terms “up”, “down”, “front”, “rear”, “left”, “right”, “vertical”, “horizontal”, “top”, “bottom”, “inside”, “outside”, and so on, indicate an orientation or positional relationship based on what is shown in the accompanying drawings. The terms are used to facilitate and simplify description of the present disclosure but do not indicate or imply that devices or elements must be arranged in a particular orientation or constructed and operated in a particular orientation. Therefore, the terms shall not be interpreted as limiting the scope of the present disclosure.

Unless otherwise defined, all technical and scientific terms used herein have the same meaning as commonly understood by any ordinary skilled person in the art. Terms used in the specification of the present disclosure are used only for the purpose of describing specific embodiments and shall not limit the present disclosure.

The present disclosure will be described below in further detail by referring to the accompanying drawings.

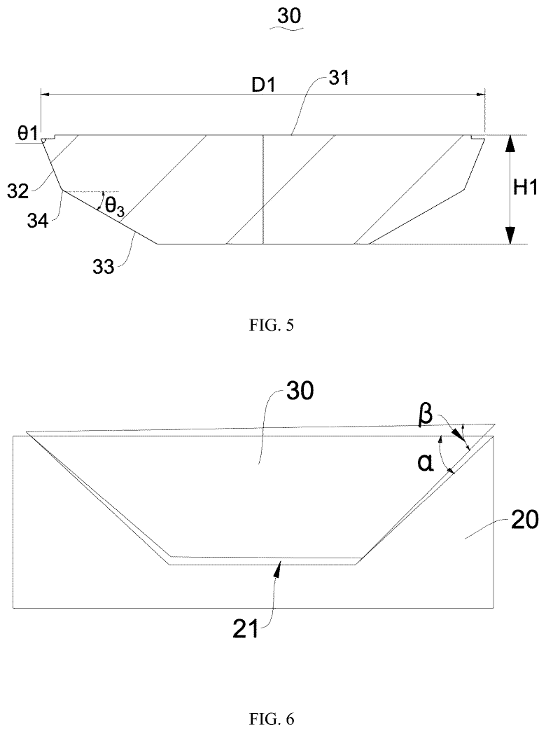

As shown in FIG. 6, which is a structural schematic view of assembling between a pole 20 on a cap body 10 and a sealing nail 30 in the art. The pole 20 defines a slot 21, and the sealing nail 30 is arranged in the slot 21. An inclination angle α is formed between a slot wall of the slot 21 and an upper surface of the pole 20. An inclination angle β is formed between a side wall of the sealing nail 30 and an upper surface of the sealing nail 30. In the art, the inclination angle α>the inclination angle β. Therefore, when the sealing nail 30 is arranged in the slot 21 during welding, due to the inclination angle of the sealing nail 30 being smaller, a location at which the sealing nail 30 is arranged in the slot 21 cannot be determined. The sealing nail 30 cannot be arranged in the slot 21 to form a flat outer surface, and the sealing nail 30 is tilted. In addition, since the sealing nail 30 is tilted, a gap between some regions of the slot wall and the sealing nail 30 may be large. Therefore, a welding effect may be poor, for example, a warped edge or a protrusion may be formed. Therefore, mating between the sealing nail 30 and the slot 21 in the art needs to be improved to prevent a poor appearance that is formed after the sealing nail is welded in the pole 20.

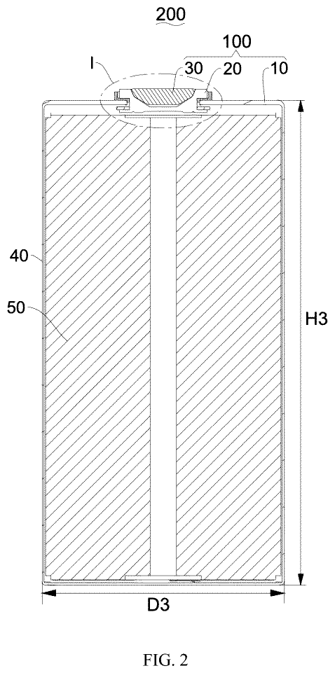

As shown in FIGS. 2 to 5, a first embodiment of the present disclosure provides a cap 100, including a cap body 10, a pole 20, and a sealing nail 30.

As shown in FIGS. 2 to 5, the pole 20 is connected to the cap body 10. The pole 20 defines a slot 21. A plane in which an upper surface of the pole 20 is located is defined as a first plane 22. The slot wall of the slot 21 includes at least a first section face 23. The first section face 23 is connected to the first plane 22. An angle between the first section face 23 and the first plane 22 is θ₂. The sealing nail 30 is arranged in the slot 21 and welded to the pole 20. A plane in which an upper surface of the sealing nail 30 is located is defined as a second plane 31. A side wall of the sealing nail 30 includes at least a first portion face 32. The first portion face 32 is connected to the second plane 31. An angle between the first portion face 32 and the second plane 31 is θ₁. The angle θ₁≥the angle θ₂.

For the cap 100 in the above embodiment, the angle θ₁ between the first portion face 32 and the second plane 31 of the sealing nail 30 is greater than the angle θ₂ between the first section face 23 and the first plane 22 of the slot 21, and therefore, when the sealing nail 30 is arranged in the slot 21 of the pole 20 to be welded to the pole 20, the side wall of the sealing nail 30 can be supported by the slot wall of the slot 21. The slot wall of the slot 21 limits the location at which the sealing nail 30 is arranged. The sealing nail 30 can be adjusted to be placed flatly in the slot 21, i.e., the second plane of the sealing nail 30 is parallel with the first plane of the pole 20. A gap between the sealing nail 30 and the slot wall at various locations may be uniform as much as possible. Compared to the technical solution in the art in which the angle θ₁ between the first portion face 32 and the second plane 31 is less than the angle θ₂ between the first section face 23 of the slot 21 and the first plane 22 of the slot 21, when the sealing nail 30 is arranged in the slot 21 and is welded to the pole by following the present disclosure, warping, protrusions, and poor welding can be avoided.

Corresponding to the angle θ₁≥angle θ₂, an outer diameter D1 of the sealing nail 30 in the present embodiment is in a range of 3 mm-20 mm, a diameter D2 of the slot 21 is in a range of 3 mm to 30 mm, and D2≥D1. For example, when θ₁=θ₂, the side wall of the sealing nail 30 is just in contact with the slot wall of the slot 21, and the sealing nail 30 and the slot wall are in a clearance fit with each other. In this case, the gap between the sealing nail 30 and the slot wall is 0, and D2=D1, for example, the outer diameter of the sealing nail 30 is 3 mm and the diameter of the slot 21 is also 3 mm. When θ₁>θ₂ and when the sealing nail 30 needs to be arranged in the slot 21, the diameter D2 of the slot 21 needs to be greater than the outer diameter D1 of the sealing nail 30. For example, when the outer diameter D1 of the sealing nail 30 is 3 mm, the diameter D2 of the slot 21 may be 3.5 mm. In this way, the sealing nail 30, which has the larger inclination angle, can be arranged in the slot 21, and the location of the sealing nail 30 in the slot 21 can be adjusted.

Furthermore, in order to facilitate production of the sealing nail 30 and defining of the slot 21, in the present embodiment, the angle θ₁>the angle θ₂ and the diameter D2>the outer diameter D1. In this way, θ₁ and θ₂ being unequal to each other and the diameter D1 and the diameter D2 being unequal to each other may be prevented, and this is because if θ₁=θ₂ and D2=D1 in theory, a production error during producing the sealing nail may be different from a production error during producing the slot of the pole, leading to the angle θ₁ being unequal to the angle θ₂ and the diameter D1 being unequal to the diameter D2. The unequal angles and the unequal diameters may result in the sealing nail 30 being unable to be placed inside the slot 21 flatly, i.e., the first plane is not parallel with the second plane, and therefore, the warping and protrusion may still be caused after the welding. Therefore, in the present embodiment, the angle θ₁>the angle θ₂ and the diameter D2>the diameter D1, ensuring that the sealing nail 30 is arranged in the slot 21 flatly and can be supported by the slot wall of the slot 21, and that the location of the sealing nail 30 can be adjusted when the sealing nail 30 is arranged on the slot wall of the slot 21, such that a better welding effect is achieved.

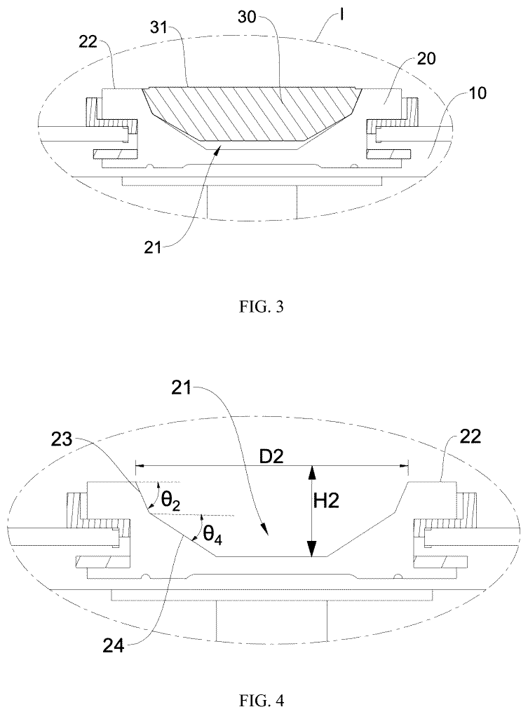

As shown in FIGS. 3 and 4, in an embodiment, in order to improve a mating effect between the sealing nail 30 and the slot 21, the slot wall of the slot 21 of the present embodiment includes the first section face 23 and a second section face 24 connected to the first section face 23. The second section face 24 is disposed away from the first plane 22. An angle between the second section face 24 and the first plane 22 is θ₄, and the angle θ₂>the angle θ₄. That is, the angle between the first section face 23 and the first plane 22 is larger than the angle between the second section face 24 and the first plane 22.

The side wall of the sealing nail 30 includes the first portion face 32 and a second portion face 33. The first portion face 32 is disposed corresponding to the first section face 23, and the second portion face 33 is disposed corresponding to the second section face 24. An angle between the second portion face 33 and the second plane 31 is θ₃, and the angle θ₁>the angle θ₃. That is, the angle between the first portion face 32 and the second plane 31 is larger than the angle between the second section face 24 and the second plane 31, and the angle θ₄≥the angle θ₃. That is, in the present embodiment, the slot wall of the slot 21 has two sections, and correspondingly, the side wall of the sealing nail 30 has two portions. In this way, when the sealing nail 30 is arranged in the slot 21, the sealing nail 30 can be supported by the slot wall of the slot 21, such that the mating between the sealing nail 30 and the slot wall of the slot 21 is ensured. The gap between the sealing nail 30 and the slot wall of the slot 21 can be adjusted, and an assembling gap between the sealing nail 30 and the slot wall can be reduced, and the poor welding is prevented. In addition, each of the sealing nail 30 and the slot wall of the slot 21 is arranged to have two-sectioned inclined faces, material of the sealing nail 30 is saved, and a size of the sealing nail 30 is reduced.

Specifically, in the present embodiment, the angle θ₄>the angle θ₃. This is because when the angle θ₄=the angle θ₃ in theory, a production error may be generated during producing the sealing nail, resulting in the ideal angle θ₄=the angle θ₃ being unable to be achieved. For example, a situation where the angle θ₄<the angle θ₃ may be resulted, and in this case, the sealing nail 30 cannot be arranged in the slot 21.

Further, in order to facilitate the location of the sealing nail 30 in the slot 21 to be adjusted, an arc transition surface 34 is formed between the first portion face 32 and the second portion face 33. It is understood that the arc transition surface 34 is a position that is in contact with the slot wall of the slot 21. Therefore, when the sealing nail 30 is adjusted in the slot 21, the arc transition surface 34 facilitates the sealing nail 30 to move in the slot 21 to adjust the location of the sealing nail 30 in the slot 21. In addition, when the location of the sealing nail 30 is being adjusted, the sealing nail 30 moves in the slot 21 in a sliding manner, such that friction between the slot wall of the slot 21 and the side wall of the sealing nail 30 is reduced, and the slot wall of the slot 21 is prevented from being scratched by the movement.

As shown in FIGS. 4 and 5, in an embodiment, a height H1 of the sealing nail 30 is in a range of 3 mm-30 mm, and a height H2 of the slot 21 is in a range of 3 mm-30 mm. In an embodiment, the height H1 of the sealing nail 30 is less than the height H2 of the slot 21. In this way, after arranging the sealing nail 30 inside the slot 21, the sealing nail 30 does not contact a bottom of the slot 21.

In the present embodiment, a welding position between the sealing nail 30 and the slot wall of the slot 21 is at an outer surface of the sealing nail 30 and a top portion of the slot wall of the slot 21. A laser source is applied to the sealing nail 30 and the pole 20 to melt the sealing nail 30 and the pole 20, and after the melted sealing nail 30 and the melted pole 20 are cooled and solidified, the sealing nail 30 and the pole 20 are connected to each other to form a one-piece and integral component.

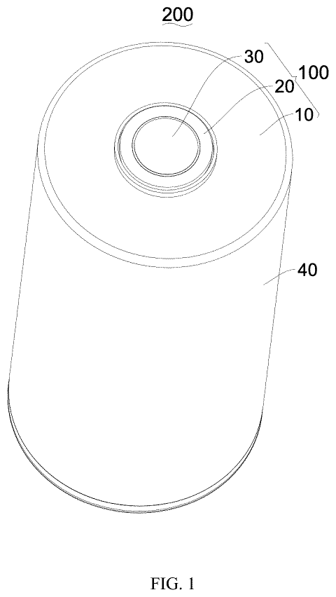

As shown in FIGS. 1 and 2, a second embodiment of the present disclosure further provides a battery 200. Specifically, the battery 200 is a cylindrical battery 200 and includes a case 40, a winding core 50, and the cover 100 as described above.

The case 40 defines a receiving space to receive the winding core 50. The winding core 50 is disposed inside the case 40. The cap 100 is configured to cover the case 40. After the cap 100 and the case 40 are assembled to each other, the cylindrical battery 200 is formed.

Specifically, an outer diameter D3 of the case 40 in the present embodiment is in a range of 20 mm-80 mm, and a total height H3 of the case 40 and the cap body 10 is in a range of 80 mm-160 mm. Therefore, a proper size of the case 40 and the height of the entire battery 200 can be determined based on a model of the battery 200.

A third embodiment of the present disclosure further provides a battery pack including the above-described battery.

Technical solutions of the present disclosure are not limited to the above embodiments but further include technical solutions formed by combination of any of the above technical features. To be noted that, any ordinary skilled person in the art may perform various improvements and embellishments without departing from principles of the present disclosure, and the improvements and embellishments shall be included in the scope of the present disclosure.

What is claimed is:

1. A cap, comprising:
a cap body;
a pole, connected to the cap body; wherein, the pole defines a slot; a plane in which an upper surface of the pole is located is defined as a first plane; a slot wall of the slot comprises at least a first section face; the first section face is connected to the first plane; an angle between the first section face and the first plane is θ₂; and
a sealing nail, arranged in the slot and welded to the pole; wherein, a plane in which an upper surface of the sealing nail is located is defined as a second plane; a side wall of the sealing nail comprises at least a first portion face; the first portion face is connected to the second plane; an angle between the first portion face and the second plane is θ₁;
wherein, the angle θ₁≥the angle θ₂.

2. The cap according to claim 1, wherein,
the slot wall of the slot comprises the first section face and a second section face connected to the first section face; the second section face is disposed away from the first plane; an angle between the first plane and a plane on which the second section face is located is θ₄, and the angle θ₂>the angle θ₄; and
the side wall of the sealing nail comprises the first portion face and a second portion face; the first portion face is disposed corresponding to the first section face, and the second portion face is disposed corresponding to the second section face; an angle between the second plane 31 and a plane on which the second portion face is located is θ₃, and the angle θ₁>the angle θ₃, the angle θ₄≥the angle θ₃.

3. The cap according to claim 2, wherein, an arc transition surface is formed between the first portion face and the second portion face.

4. The cap according to claim 2, wherein, the angle θ₄>the angle θ₃.

5. The cap according to claim 1, wherein, an outer diameter D1 of the sealing nail is in a range of 3 mm-20 mm, a diameter D2 of the slot is in a range of 3 mm to 30 mm, and the diameter D2≥the outer diameter D1.

6. The cap according to claim 1, wherein,
the slot wall of the slot comprises the first section face and a second section face connected to the first section face; the second section face is disposed away from the first plane; an angle between the first plane and a plane on which the second section face is located is θ₄, and the angle θ₂>the angle θ₄;
the side wall of the sealing nail comprises the first portion face and a second portion face; the first portion face is disposed corresponding to the first section face, and the second portion face is disposed corresponding to the second section face; an angle between the second plane 31 and a plane on which the second portion face is located is θ₃, and the angle θ₁>the angle θ₃, the angle θ₄≥the angle θ₃; and
an outer diameter D1 of the sealing nail is in a range of 3 mm-20 mm, a diameter D2 of the slot is in a range of 3 mm to 30 mm, and the diameter D2≥the outer diameter D1.

7. The cap according to claim 1, wherein,
the slot wall of the slot comprises the first section face and a second section face connected to the first section face; the second section face is disposed away from the first plane; an angle between the first plane and a plane on which the second section face is located is θ₄, and the angle θ₂>the angle θ₄;
the side wall of the sealing nail comprises the first portion face and a second portion face; the first portion face is disposed corresponding to the first section face, and the second portion face is disposed corresponding to the second section face; an angle between the second plane 31 and a plane on which the second portion face is located is θ₃, and the angle θ₁>the angle θ₃, the angle θ₄≥the angle θ₃;
an arc transition surface is formed between the first portion face and the second portion face; and
an outer diameter D1 of the sealing nail is in a range of 3 mm-20 mm, a diameter D2 of the slot is in a range of 3 mm to 30 mm, and the diameter D2≥the outer diameter D1.

8. The cap according to claim 1, wherein,
the slot wall of the slot comprises the first section face and a second section face connected to the first section face; the second section face is disposed away from the first plane; an angle between the first plane and a plane on which the second section face is located is θ₄, and the angle θ₂>the angle θ₄;
the side wall of the sealing nail comprises the first portion face and a second portion face; the first portion face is disposed corresponding to the first section face, and the second portion face is disposed corresponding to the second section face; an angle between the second plane 31 and a plane on which the second portion face is located is θ₃, and the angle θ₁>the angle θ₃, the angle θ₄>the angle θ₃; and
an outer diameter D1 of the sealing nail is in a range of 3 mm-20 mm, a diameter D2 of the slot is in a range of 3 mm to 30 mm, and the diameter D2≥the outer diameter D1.

9. The cap according to claim 5, wherein, the angle θ₁>the angle θ₂, and the diameter D2>the outer diameter D1.

10. The cap according to claim 1, wherein, a height H1 of the sealing nail is in a range of 3 mm-30 mm, and a height H2 of the slot is in a range of 3 mm-30 mm.

11. A battery, comprising:
a case;
a winding core, arranged in the case; and
a cap, wherein, the cap covers the case and comprises:
a cap body;
a pole, connected to the cap body; wherein, the pole defines a slot; a plane in which an upper surface of the pole is located is defined as a first plane; a slot wall of the slot comprises at least a first section face; the first section face is connected to the first plane; an angle between the first section face and the first plane is θ₂; and
a sealing nail, arranged in the slot and welded to the pole; wherein, a plane in which an upper surface of the sealing nail is located is defined as a second plane;
a side wall of the sealing nail comprises at least a first portion face; the first portion face is connected to the second plane; an angle between the first portion face and the second plane is θ₁;
wherein, the angle θ₁≥the angle θ₂.

12. The battery according to claim 11, wherein,
the slot wall of the slot comprises the first section face and a second section face connected to the first section face; the second section face is disposed away from the first plane; an angle between the first plane and a plane on which the second section face is located is θ₄, and the angle θ₂>the angle θ₄; and
the side wall of the sealing nail comprises the first portion face and a second portion face; the first portion face is disposed corresponding to the first section face, and the second portion face is disposed corresponding to the second section face; an angle between the second plane 31 and a plane on which the second portion face is located is θ₃, and the angle θ₁>the angle θ₃, the angle θ₄≥the angle θ₃.

13. The battery according to claim 12, wherein, an arc transition surface is formed between the first portion face and the second portion face.

14. The battery according to claim 12, wherein, the angle θ₄>the angle θ₃.

15. The battery according to claim 11, wherein, an outer diameter D1 of the sealing nail is in a range of 3 mm-20 mm, a diameter D2 of the slot is in a range of 3 mm to 30 mm, and the diameter D2≥the outer diameter D1.

16. The battery according to claim 11, wherein,
the slot wall of the slot comprises the first section face and a second section face connected to the first section face; the second section face is disposed away from the first plane; an angle between the first plane and a plane on which the second section face is located is θ₄, and the angle θ₂>the angle θ₄;
the side wall of the sealing nail comprises the first portion face and a second portion face; the first portion face is disposed corresponding to the first section face, and the second portion face is disposed corresponding to the second section face; an angle between the second plane 31 and a plane on which the second portion face is located is θ₃, and the angle θ₁>the angle θ₃, the angle θ₄≥the angle θ₃; and
an outer diameter D1 of the sealing nail is in a range of 3 mm-20 mm, a diameter D2 of the slot is in a range of 3 mm to 30 mm, and the diameter D2≥the outer diameter D1.

17. The battery according to claim 11, wherein,
the slot wall of the slot comprises the first section face and a second section face connected to the first section face; the second section face is disposed away from the first plane; an angle between the first plane and a plane on which the second section face is located is θ₄, and the angle θ₂>the angle θ₄;
the side wall of the sealing nail comprises the first portion face and a second portion face; the first portion face is disposed corresponding to the first section face, and the second portion face is disposed corresponding to the second section face; an angle between the second plane 31 and a plane on which the second portion face is located is θ₃, and the angle θ₁>the angle θ₃, the angle θ₄≥the angle θ₃;
an arc transition surface is formed between the first portion face and the second portion face; and
an outer diameter D1 of the sealing nail is in a range of 3 mm-20 mm, a diameter D2 of the slot is in a range of 3 mm to 30 mm, and the diameter D2≥the outer diameter D1.

18. The battery according to claim 11, wherein,
the slot wall of the slot comprises the first section face and a second section face connected to the first section face; the second section face is disposed away from the first plane; an angle between the first plane and a plane on which the second section face is located is θ₄, and the angle θ₂>the angle θ₄;
the side wall of the sealing nail comprises the first portion face and a second portion face; the first portion face is disposed corresponding to the first section face, and the second portion face is disposed corresponding to the second section face; an angle between the second plane 31 and a plane on which the second portion face is located is θ₃, and the angle θ₁>the angle θ₃, the angle θ₄>the angle θ₃; and
an outer diameter D1 of the sealing nail is in a range of 3 mm-20 mm, a diameter D2 of the slot is in a range of 3 mm to 30 mm, and the diameter D2≥the outer diameter D1.

19. The battery according to claim 11, wherein, an outer diameter D3 of the case is in a range of 20 mm-80 mm, and a total height H3 of the case and the cap body is in a range of 80 mm-160 mm.

20. A battery pack, comprising a battery;
wherein, the battery comprises: a case; a winding core, arranged in the case; and a cap,
wherein, the cap covers the case and comprises:
a cap body;
a pole, connected to the cap body; wherein, the pole defines a slot; a plane in which an upper surface of the pole is located is defined as a first plane; a slot wall of the slot comprises at least a first section face; the first section face is connected to the first plane; an angle between the first section face and the first plane is θ₂; and
a sealing nail, arranged in the slot and welded to the pole; wherein, a plane in which an upper surface of the sealing nail is located is defined as a second plane;
a side wall of the sealing nail comprises at least a first portion face; the first portion face is connected to the second plane; an angle between the first portion face and the second plane is θ₁;
wherein, the angle θ₁≥the angle θ₂.
